(19) United States
(12) Patent Application Publication
(10) Pub. No.: US 2004/0258225 A1
(43) Pub. Date: Dec. 23, 2004

(54) Method and apparatus for reliable and secure facsimile communications, and program and computer-readable medium storing the program for reliable and secure facsimile communications

(76) Inventor: Masashi Takubo, Tokyo (JP)

Correspondence Address: Ivan S. Kavrukov, Esq., Cooper & Dunham LLP, 1185 Avenue of the Americas, New York, NY, 10036, US

(21) Appl. No.: 10/766,724

(22) Filed: Jan. 27, 2004

(30) Foreign Application Priority Data
Jan. 28, 2003 (JP) JPAP 2003-018722

(51) Int. Cl. H04M 11/00

(52) U.S. Cl. 379/100.01; 379/100.05; 379/100.17

(57) ABSTRACT

A facsimile apparatus includes a facsimile communications mechanism, a first storage mechanism, a second storage mechanism, a backup arranging mechanism, a determining mechanism, and a control mechanism. The facsimile communications mechanism performs a facsimile communications operation. The first storage mechanism is inaccessible and the second storage mechanism is accessible through the local area network. The backup arranging mechanism stores received document data into the first storing mechanism and stores a copy of the received document data into the second storing mechanism. The determining mechanism determines whether the received document data is confidential. The control mechanism causes the backup arranging mechanism to cancel storing a copy of the received document data into the second storing mechanism when the received document data is determined as confidential.

### BACKGROUND

1. Field

This specification describes a method and apparatus for reliable and secure facsimile communications, and more particularly a method and apparatus for reliable and secure facsimile communications using a controlled backup memory. This specification also describes a program for executing the above-mentioned method with a computer and a computer-readable medium storing the program.

2. Discussion of the Related Arts

In recent years, a facsimile apparatus has been developed which transfers received facsimile data to a PC (personal computer) connected thereto via a network so that a user can easily view the contents of the received facsimile data without the needs of reproducing the data. Such a facsimile apparatus needs to hold the data in a memory until it receives a print instruction or a transfer request from the PC. In this facsimile apparatus, if the data is stored only in the memory, it is possible that the stored data is lost when power fails or is shut down, for example.

In some facsimile apparatuses and multi-function apparatuses, a hard disk is installed to store a relatively large amount of data. In some of these apparatuses, the hard disk is also used as a backup memory for storing the received facsimile data to attempt to solve the above-mentioned problem.

As examples, Japanese Laid-Open Patent Application Publications, No. 1-229543 and No. 5-48648, describe apparatuses each of which employs a plurality of backup storage devices to attempt to prevent a loss of data due to a failure of the storing devices.

Further, some of recent facsimile apparatuses form a multi-function apparatus capable of performing multiple functions including copying, printing, networking with PCs, data transmission, etc. In these apparatuses, each of the multiple functions performs series of data processing operations such as storing, printing, and editing, for example, typically with using a common hard disk. In these apparatuses, one problem associated with received facsimile data is that the received facsimile data is accessed before the execution of reproduction by a PC or a function other than the facsimile function which may change or delete the contents of the received facsimile data before a user views the data. Therefore, it is preferable that the received facsimile data is not accessed by a PC or a function other than the facsimile function before the execution of reproducing the received facsimile data. As one attempt to solve this problem, in some facsimile apparatuses, the received facsimile data stored in a memory exclusively accessible by the facsimile function is also stored in a hard disk accessible from a PC over a network or a function other than the facsimile function.

However, there may be a confidential information handling function in the facsimile procedure of a facsimile apparatus, in which the information is printed only when a pass code is entered. The above-mentioned facsimile apparatus which has a generally accessible hard disk to store the backup of the received facsimile data needs provisions for careful handling of confidential information.

### SUMMARY

According to one exemplary embodiment, a novel facsimile apparatus which is coupled to a telephone line network and a local area network and is capable of assuring information confidentiality and increasing reliability of data storage includes a facsimile communications mechanism, a first storage mechanism, a second storage mechanism, a backup arranging mechanism, a determining mechanism, and a control mechanism. The facsimile communications mechanism is configured to perform a facsimile communications operation. The first storage mechanism is configured to store data and to be inaccessible through the local area network. The second storage mechanism is configured to store data and to be accessible through the local area network. The backup arranging mechanism is configured to store received document data into the first storage mechanism and to store a copy of the received document data into the second storage mechanism. The determining mechanism is configured to determine whether the received document data is confidential. The control mechanism is configured to cause the backup arranging mechanism to cancel storing a copy of the received document data into the second storage mechanism when the received document data is determined as confidential by the determining mechanism.

Further, to achieve the above-mentioned object and other objects, a novel facsimile apparatus which is coupled to a telephone line network and a local area network and is capable of assuring information confidentiality and increasing reliability of data storage, according to another exemplary embodiment, includes a facsimile communications mechanism, a first storage mechanism, a second storage mechanism, a backup arranging mechanism, a determining mechanism, and a control mechanism. The facsimile communications mechanism is configured to perform a facsimile communications operation. The first storage mechanism is configured to store data and to be inaccessible through the local area network. The second storage mechanism is configured to store data and to be accessible through the local area network. The backup arranging mechanism is configured to store received document data into the first storage mechanism and to store a copy of the received document data into the second storage mechanism. The determining mechanism is configured to determine whether the received document data stored in the second storage mechanism is confidential upon a receipt of a data transmission request for transmitting the received document data stored in the second storage mechanism from an external terminal through the local area network. The control mechanism is configured to refuse the data transmission request from the external terminal through the local area network when the received document data is determined as confidential by the determining mechanism.

Further, to achieve the above-mentioned object and other objects, a novel facsimile apparatus which is coupled to a telephone line network and a local area network and is capable of assuring information confidentiality and increasing reliability of data storage, according to another exemplary embodiment, includes a facsimile communications mechanism, a web server mechanism, a first storage mechanism, a second storage mechanism, a backup arranging mechanism, a determining mechanism, and a control mechanism. The facsimile communications mechanism is configured to perform a facsimile communications operation. The web server mechanism is configured to allow a web browser to show received document data. The first storage mechanism is configured to store data and to be inaccessible through the local area network. The second storage mechanism is configured to store data and to be accessible through the local area network. The backup arranging mechanism is configured to store received document data into the first storage mechanism and to store a copy of the received document data into the second storage mechanism. The determining mechanism is configured to determine whether the received document data stored in the second storage mechanism is confidential upon a receipt of a data transmission request for transmitting the received document data stored in the second storage mechanism from a web browser through the local area network. The control mechanism is configured to refuse the data transmission request from the web browser through the local area network when the received document data is determined as confidential by the determining mechanism.

Further, to achieve the above-mentioned object and other objects, according to one exemplary embodiment, a novel communications method for a facsimile apparatus which is coupled to a telephone line network and a local area network and is capable of assuring information confidentiality and increasing reliability of data storage includes the steps of performing, determining, storing, and copying. The performing step performs a facsimile communications operation. The determining step determines whether the received document data is confidential. The storing step stores received document data into a first memory inaccessible through the local area network. The copying step copies the received document data into a second memory accessible through the local area network when the received document data is determined as not confidential by the determining step. In this method, the copying step is cancelled when the received document data is determined as confidential by the determining step.

Further, to achieve the above-mentioned object and other objects, according to an exemplary embodiment, a novel computer readable data recording medium storing a program which is executed by a computer to perform operations according to a communications method for a facsimile apparatus coupled to a telephone line network and a local area network includes the steps of performing, storing, copying, determining, and refusing. The performing step performs a facsimile communications operation. The storing step stores received document data into a first memory inaccessible through the local area network. The copying step copies the received document data into a second memory accessible through the local area network. The determining step determines whether the received document data stored in the second memory is confidential upon a receipt of a data transmission request for transmitting the received document data stored in the second memory from a web browser through the local area network. The refusing step refuses the data transmission request from the web browser through the local area network when the received document data is determined as confidential by the determining step.

Thus, the tools (for example, methodologies and apparatuses) of this disclosure may be embodied in a computer program stored on a computer readable medium and/or transmitted (in one or more segments) via a computer network or another transmission medium.

### BRIEF DESCRIPTION OF THE DRAWINGS

A more complete appreciation of the present disclosure and many of the attendant advantages thereof can be more readily understood from the following detailed description when considered in connection with the accompanying drawings, wherein:

FIG. 1 is a schematic block diagram of a facsimile apparatus, according an exemplary embodiment;

FIG. 2 is a flowchart showing an exemplary data receiving operation performed by the facsimile apparatus of FIG. 1;

FIG. 3 is a flowchart showing an exemplary operation, performed by the facsimile apparatus of FIG. 1, for transmitting received facsimile data to a personal computer;

FIG. 4 is a flowchart showing an exemplary operation, performed by the facsimile apparatus of FIG. 1, for transmitting received facsimile data to a web browser; and

FIG. 5 is a schematic block diagram of an exemplary structure of a control system performing a software program which executes a control procedure of the facsimile apparatus of FIG. 1.

### DETAILED DESCRIPTION OF PREFERRED EMBODIMENTS

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

A description of some exemplary embodiments is provided below with reference to the drawings, wherein like reference numerals designate identical or corresponding parts throughout several views.

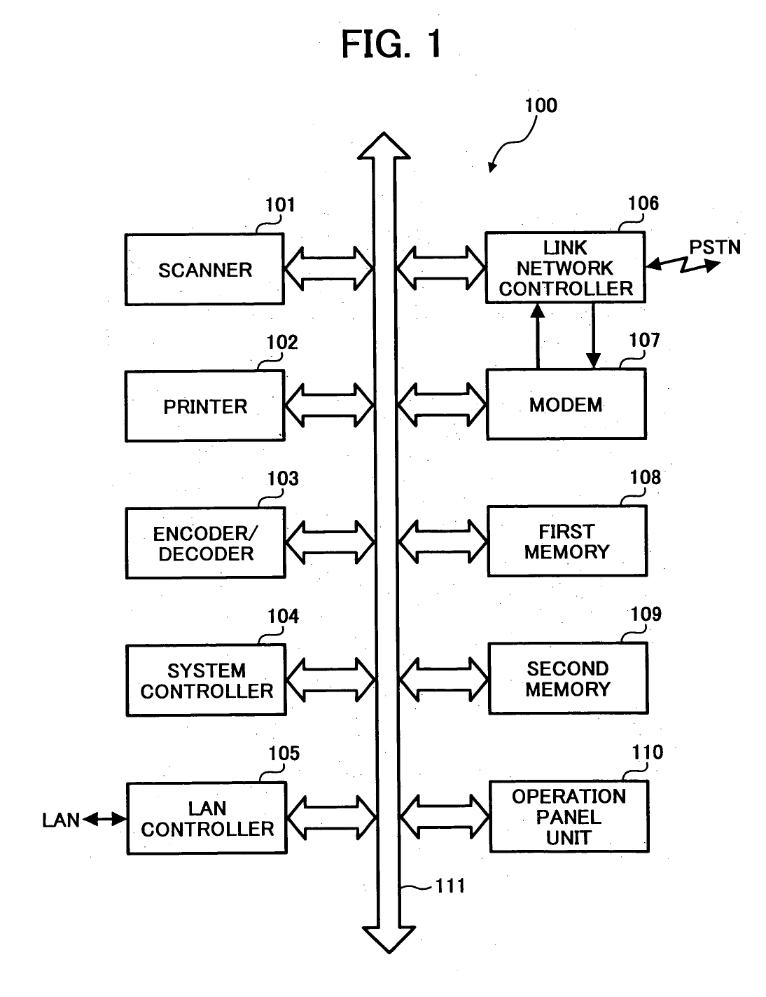

For example, a facsimile apparatus 100 is shown in FIG. 1 as one example of an image forming apparatus, according to an exemplary embodiment. As illustrated in FIG. 1, the facsimile apparatus 100 includes a scanner 101, a printer 102, an encoder and decoder 103, a system controller 104, a LAN (local area network) controller 105, a line network controller 106, a modem 107, a first memory 108, a second memory 109, an operation panel unit 110, and a system bus 111.

The scanner 101 reads an original and output image information. The printer 102 prints image information. The encoder and decoder 103 performs encoding and decoding operations relative to image information. The system controller 104 controls operations of the facsimile apparatus 100. The LAN controller 105 controls transmission and receiving of information to and from a local area network (LAN) to which the facsimile apparatus 100 is connected. The line network controller 106 controls transmission and receiving of information to and from a public switched telephone network (PSTN) to which the facsimile apparatus 100 is connected. The modem 107 exchanges data with an external personal computer (PC) via the line network controller 106. The first memory 108 is a memory not accessible from outside the facsimile apparatus 100. The second memory 109 is a memory accessible from outside the facsimile apparatus 100, for example, from the external PC via the LAN controller 105. The operation panel unit 110 allows users to enter instructions and data which are processed inside the facsimile apparatus 100 and/or are indicated on a display included in the operation panel unit 110. The facsimile apparatus 100 has a data backup function in which the facsimile apparatus 100 checks the contents of the first and second memories 108 and 109 at a power-on time and, when one of the first and second memories 108 and 109 loses its contents, duplicates the contents of the memory holding its contents to the memory which lost the contents.

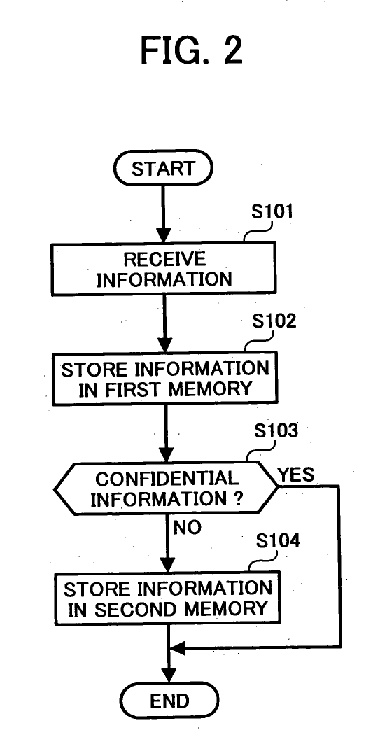

Referring to FIG. 2, an exemplary procedure of a document storage operation for storing a received document performed by the facsimile apparatus 100 is explained. In Step S101, the facsimile apparatus 100 receives a facsimile document from a PC (not shown) through a telephone line. Upon a receipt of the facsimile document, the system controller 104 stores the received facsimile document into the first memory 108, in Step S102. Then, in Step S103, the system controller 104 determines whether the received facsimile document is confidential. When the received facsimile document is determined as not confidential and the determination result of Step S103 is NO, the system controller 104 stores the received facsimile document into the second memory 109, in Step S104. When the received facsimile document is determined as confidential and the determination result of Step S103 is YES, the process ends.

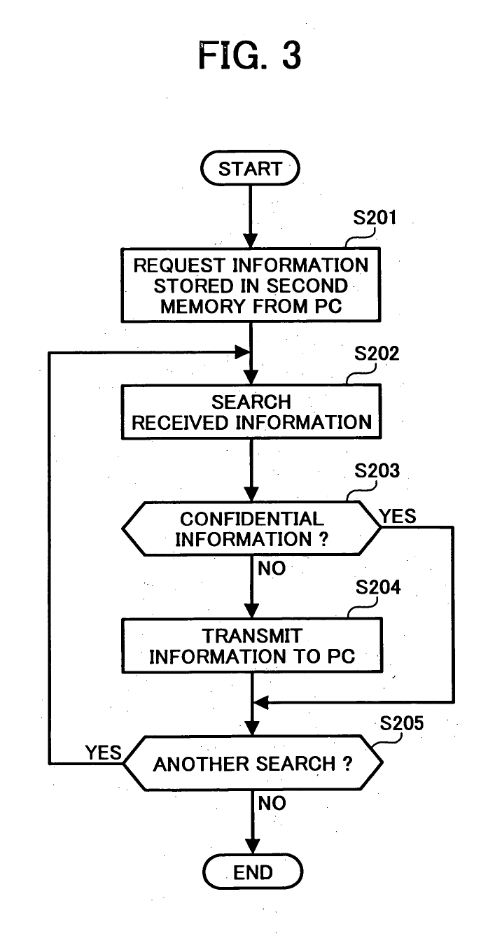

Referring to FIG. 3, an exemplary procedure of a document referring operation for referring to a received document performed by the facsimile apparatus 100 is explained. In Step S201, the facsimile apparatus 100 receives a request from a PC (not shown) through the LAN controller 105 for referring to a received facsimile document stored in the second memory, 109. Upon a receipt of the request, the system controller 104 searches the received facsimile document stored in the second memory 109, in Step 5202. Then, in Step S203, the system controller 104 determines whether the received facsimile document searched is confidential. When the received facsimile document searched is determined as not confidential and the determination result of Step S203 is NO, the system controller 104 transmits the received facsimile document searched to the PC via the LAN controller 105, in Step S204. Then, the process proceeds to Step S205 and the system controller 104 determines whether another received facsimile document to be searched exists. When another received facsimile document to be searched is determined as existing and the determination result of Step S205 is YES, the process returns to Step S202 to repeat the same procedure from the searching step. When another received facsimile document to be searched is determined as not existing and the determination result of Step S205 is NO, the process ends.

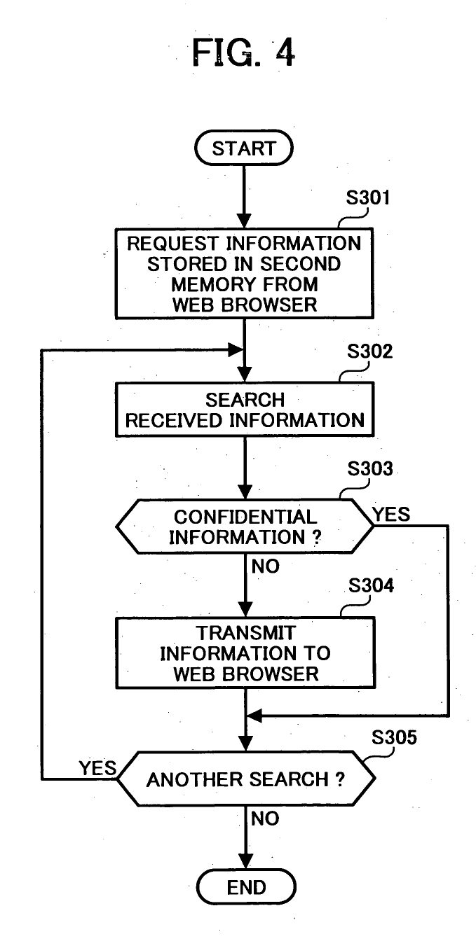

Referring to FIG. 4, an exemplary procedure of another document referring operation performed by the facsimile apparatus 100 is explained. In this case, the document referring operation is requested by a web browser. In Step S301, the facsimile apparatus 100 receives a request from a web browser (not shown) through the LAN controller 105 for referring to a received facsimile document stored in the second memory 109. Upon a receipt of the request, the system controller 104 searches the received facsimile document stored in the second memory 109, in Step S302. Then, in Step S303, the system controller 104 determines whether the received facsimile document searched is confidential. When the received facsimile document searched is determined as not confidential and the determination result of Step S303 is NO, the system controller 104 transmits the received facsimile document searched to the web browser via the LAN controller 105, in Step S304. Then, the process proceeds to Step S305 and the system controller 104 determines whether another received facsimile document to be searched exists. When another received facsimile document to be searched is determined as existing and the determination result of Step S305 is YES, the process returns to Step S302 to repeat the same procedure from the searching step. When another received facsimile document to be searched is determined as not existing and the determination result of Step S305 is NO, the process ends.

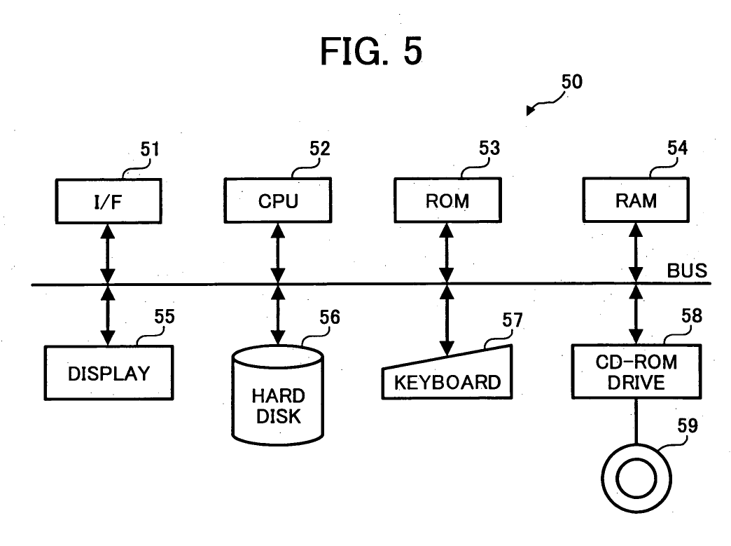

Referring to FIG. 5, an exemplary structure of a hardware system 50 executing a software program according to the control procedure performed by the image forming apparatus according to the present disclosure. As shown in FIG. 5, the control system 50 includes an interface (I/F) 51, a CPU (central processing unit) 52, a ROM (read only memory) 53, a RAM (random access memory) 54, a display 55, a hard disk 56, a keyboard 57, and a CD-ROM drive 58. The control system 50 may be a general purpose personal computer. A software program executing the control procedure of the image forming apparatus according to the present disclosure can be stored in a computer readable medium such as a CD-ROM 59, for example, or transmitted via a computer network (for example, an Internet or a LAN) or another transmission network. Various control signals can be input to the control system 50 from an external apparatus via the interface 51, and the software program of the present invention is started automatically or with a user instruction through the keyboard 57. Then, in accordance with the software program, the CPU 52 executes various control operations associated with the control procedure of the image forming apparatus according to the present disclosure. During the program execution, the CPU 52 stores the processing results into the PAM 54 and the hard disk 56 and displays the information on the display 55 as needed. In this way, a control system for the image forming apparatus of the present invention may generally be formed without the needs of modifying the existing system by using a data recording medium storing a software program executing the control procedure of the image forming apparatus according to the present disclosure.

The above-described examples may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art. The examples may also be implemented by the preparation of application specific integrated circuits or by interconnecting an appropriate network of conventional component circuits, as will be readily apparent to those skilled in the art.

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

This patent specification is based on Japanese patent application, No. JPAP2003-18722 filed on Jan. 28, 2003 in the Japanese Patent Office, the entire contents of which are incorporated by reference herein.

What is claimed is:

1. A facsimile apparatus coupled to a telephone line network and a local area network, comprising:
a facsimile communications mechanism configured to perform a facsimile communications operation;
a first storage mechanism configured to store data and to be inaccessible through the local area network;
a second storage mechanism configured to store data and to be accessible through the local area network;
a backup arranging mechanism configured to store received document data into the first storage mechanism and to store a copy of the received document data into the second storage mechanism;
a determining mechanism configured to determine whether the received document data is confidential; and
a control mechanism configured to cause the backup arranging mechanism to cancel storing a copy of the received document data into the second storage mechanism when the received document data is determined as confidential by the determining mechanism.

2. A facsimile apparatus coupled to a telephone line network and a local area network, comprising:
a facsimile communications mechanism configured to perform a facsimile communications operation;
a first storage mechanism configured to store data and to be inaccessible through the local area network;
a second storage mechanism configured to store data and to be accessible through the local area network;
a backup arranging mechanism configured to store received document data into the first storage mechanism and to store a copy of the received document data into the second storage mechanism;
a determining mechanism configured to determine whether the received document data stored in the second storage mechanism is confidential upon a receipt of a data transmission request for transmitting the received document data stored in the second storage mechanism from an external terminal through the local area network; and
a control mechanism configured to refuse the data transmission request from the external terminal through the local area network when the received document data is determined as confidential by the determining mechanism.

3. A facsimile apparatus coupled to a telephone line network and a local area network, comprising:
a facsimile communications mechanism configured to perform a facsimile communications operation;
a web server mechanism configured to allow a web browser to show received document data;
a first storage mechanism configured to store data and to be inaccessible through the local area network;
a second storage mechanism configured to store data and to be accessible through the local area network;
a backup arranging mechanism configured to store received document data into the first storage mechanism and to store a copy of the received document data into the second storage mechanism;
a determining mechanism configured to determine whether the received document data stored in the second storage mechanism is confidential upon a receipt of a data transmission request for transmitting the received document data stored in the second storage mechanism from a web browser through the local area network; and
a control mechanism configured to refuse the data transmission request from the web browser through the local area network when the received document data is determined as confidential by the determining mechanism.

4. A facsimile apparatus coupled to a telephone line network and a local area network, comprising:
communication means for performing a facsimile communications operation;
first storage means inaccessible through the local area network for storing data;
second storage means accessible through the local area network for storing data;
backup arranging means for storing received document data into the first storage means and storing a copy of the received document data into the second storage means;
determining means for determining whether the received document data is confidential; and
control means for causing the backup arranging means to cancel storing a copy of the received document data into the second storage means when the received document data is determined as confidential by the determining means.

5. A facsimile apparatus coupled to a telephone line network and a local area network, comprising:
communication means for performing a facsimile communications operation;
first storage means inaccessible through the local area network for storing data;
second storage means accessible through the local area network for storing data;
backup arranging means for storing received document data into the first storage means and storing a copy of the received document data into the second storage means;
determining means for determining whether the received document data stored in the second storage means is confidential upon a receipt of a data transmission request for transmitting the received document data stored in the second storage means from an external terminal through the local area network; and
control means for refusing the data transmission request from the external terminal through the local area network when the received document data is determined as confidential by the determining means.

6. A facsimile apparatus coupled to a telephone line network and a local area network, comprising:
communicating means for performing a facsimile communications operation;
web server means for allowing a web browser to show received document data;
first storage means inaccessible through the local area network for storing data;
second storage means accessible through the local area network for storing data;
backup arranging means for storing received document data into the first storage means and storing a copy of the received document data into the second storage means;
determining means for determining whether the received document data stored in the second storage means is confidential upon a receipt of a data transmission request for transmitting the received document data stored in the second storage means from a web browser through the local area network; and
control means for refusing the data transmission request from the web browser through the local area network when the received document data is determined as confidential by the determining means.

7. A communications method for a facsimile apparatus coupled to a telephone line network and a local area network, comprising the steps of:
performing a facsimile communications operation;
determining whether the received document data is confidential;
storing received document data into a first memory inaccessible through the local area network; and
copying the received document data into a second memory accessible through the local area network when the received document data is determined as not confidential by the determining step,
wherein the copying step is cancelled when the received document data is determined as confidential by the determining step.

8. A communications method for a facsimile apparatus coupled to a telephone line network and a local area network, comprising the steps of:
performing a facsimile communications operation;
storing received document data into a first memory inaccessible through the local area network;
copying the received document data into a second memory accessible through the local area network;
determining whether the received document data stored in the second memory is confidential upon a receipt of a data transmission request for transmitting the received document data stored in the second memory from an external terminal through the local area network; and
refusing the data transmission request from the external terminal through the local area network when the received document data is determined as confidential by the determining step.

9. A communications method for a facsimile apparatus coupled to a telephone line network and a local area network, comprising the steps of:
performing a facsimile communications operation;
storing received document data into a first memory inaccessible through the local area network;
copying the received document data into a second memory accessible through the local area network;
determining whether the received document data stored in the second memory is confidential upon a receipt of a data transmission request for transmitting the received document data stored in the second memory from a web browser through the local area network; and
refusing the data transmission request from the web browser through the local area network when the received document data is determined as confidential by the determining step.

10. A computer readable data recording medium storing a program which causes a computer to execute operations according to a communications method for a facsimile apparatus coupled to a telephone line network and a local area network, comprising the steps of:
performing a facsimile communications operation;
storing received document data into a first memory inaccessible through the local area network;
copying the received document data into a second memory accessible through the local area network;
determining whether the received document data stored in the second memory is confidential upon a receipt of a data transmission request for transmitting the received document data stored in the second memory from a web browser through the local area network; and
refusing the data transmission request from the web browser through the local area network when the received document data is determined as confidential by the determining step.

11. A program storage device readable by a machine, tangibly embodying a program of instructions executable by the machine to perform the method claimed in claim 7.

12. A computer system, comprising:
a processor; and
a program storage device readable by the computer system, tangibly embodying a program of instructions executable by the processor to perform the method claimed in claim 7.

13. A computer data signal transmitted in one or more segments in a transmission medium which embodies instructions executable by a computer to perform the method claimed in claim 7.

14. A program storage device readable by a machine, tangibly embodying a program of instructions executable by the machine to perform the method claimed in claim 8.

15. A computer system, comprising:
a processor; and
a program storage device readable by the computer system, tangibly embodying a program of instructions executable by the processor to perform the method claimed in claim 8.

16. A computer data signal transmitted in one or more segments in a transmission medium which embodies instructions executable by a computer to perform the method claimed in claim 8.

17. A program storage device readable by a machine, tangibly embodying a program of instructions executable by the machine to perform the method claimed in claim 9.

18. A computer system, comprising:
a processor; and
a program storage device readable by the computer system, tangibly embodying a program of instructions executable by the processor to perform the method claimed in claim 9.

19. A computer data signal transmitted in one or more segments in a transmission medium which embodies instructions executable by a computer to perform the method claimed in claim 9.
